(19) United States
(12) Patent Application Publication
(10) Pub. No.: US 2003/0036323 A1
(43) Pub. Date: Feb. 20, 2003

(54) Shelf liner/table top assembly

(76) Inventor: Reza Aliabadi, Nashville, TN (US)

Correspondence Address: Richard C. Litman, LITMAN LAW OFFICES, LTD., P.O. Box 15035, Arlington, VA, 22215, US

(21) Appl. No.: 09/931,059

(22) Filed: Aug. 17, 2001

(51) Int. Cl. B32B 27/04; B32B 27/12; B32B 27/32; B32B 5/02; B32B 7/12; B32B 15/04

(52) U.S. Cl. 442/40; 442/38; 442/43

(57) ABSTRACT

A plastic shelf liner/table top assembly comprising a top layer of a smooth polyvinyl chloride covering a sandwich layer of a polyester fabric between layers of polyvinyl chloride which was heat bonded resulting in a non-slip bottom surface. A decorative design can be incorporated by imprinting the design on the sandwich layer before covering with the top layer. The total thickness can vary from 1 to 10 mm.

### BACKGROUND OF THE INVENTION

1. Field of the Invention

The present invention relates generally to planar covers. More specifically, the invention is a four-layer, unitized, decorative shelf liner and decorative tabletop cover assembly having a non-slip and non-adhesive bottom layer.

2. Description of the Related Art

The related art of interest describes various shelf liner and table top covers, but none describes the present invention. There is a need for an economical, waterproof, dual-purpose cover assembly for shelves and table tops having a frictionless, flexible, decorative, top surface and a non-adhesive, non-slip bottom surface. The related art will be discussed in the order of perceived relevance to the present invention.

U.S. Pat. No. 6,221,796 B1 issued on Apr. 24, 2001, to James K. Hawley et al. describes a smooth surfaced foam laminate and a method of making the laminate. The laminate comprises a smooth, continuous, laminated top layer and a discontinuous porous foam bottom layer comprising a loosely woven scrim (cotton fabric) having a rubber or plastic material foamed onto the scrim. The product is usable as a drawer liner, shelf liner and a appliance underlayment. The laminate is distinguishable for requiring a discontinuous porous foam bottom layer comprising rubber or vinyl.

U.S. Pat. No. 5,827,787 issued on Oct. 27, 1998, to William W. White describes a decorative weatherable fabric for covering outdoor backlit structures comprising a reinforcing scrim layer, two inner protective layers of translucent white polyvinyl chloride (PVC) layer having different thicknesses applied to the sides of the scrim layer, and a colored polyvinyl fluoride (PVF) top layer. Pressure sensitive decorative films may be applied to portions of a transparent layer of a reader panel for an awning. The layers of PVC are adhered to the scrim layer with a plastisol adhesive. The fabric is distinguishable for a requiring top layer of PVF and bonding the PVC layers to the scrim by an adhesive.

U.S. Pat. No. 6,022,617 issued on Feb. 8, 2000, to Mark A. Calkins describes a decorative non-slip liner or mat comprising a decorated vinyl sheet adhered by adhesive to a smooth, nonwoven, spun bond polyester substrate which has a printed bottom surface of PVC projections. The product is distinguishable for its vinyl-polyester-PVC composition.

U.S. Pat. No. 5,747,133 issued on May 5, 1998, to Yashavant V. Vinod et al. describes a decorative composite floor covering comprising a decorative layer having a fabric base and a plastic matrix having a transparent portion which lies on a stabilizing layer of scrim and an optional bottom layer of a cushioning material. The floor covering is distinguishable for its three-layered structure.

U.S. Pat. No. 2,418,904 issued on Apr. 15, 1947, to Edward W. Rugeley et al. describes the production of reinforced composite structures comprising a preformed reinforcing fabric made of yarns, threads or filaments of an unplasticized vinyl resin between two continuous sheets, films or webs of a water-insoluble thermoplastic vinyl resin containing a plasticizer. The product is used for packaging materials. The process and product are distinguishable for its essentially vinyl structure.

U.S. Pat. No. 3,360,422 issued on Dec. 26, 1967, to Robert P. Desch describes a reinforced cellular floor covering comprising a PVC top surface, an open weave scrim, and a cellular PVC backing layer.

U.S. Pat. No. 3,619,315 issued on Nov. 9, 1971, to David I. Carrack et al. describes a method of manufacturing a polyurethane coated sheeted material for improved flex-life.

U.S. Pat. No. 3,649,324 issued on Mar. 14, 1972, to Harold J. W. Payne describes a method of applying a coating of rigid, closed cell polymeric foam to a substrate.

U.S. Pat. No. 3,670,049 issued on Jun. 13, 1972, to Alex H. Stein et al. describes a bowling lane finish containing a polyurethane and a polyolefin.

U.S. Pat. No. 4,087,400 issued on May 21, 1978, to David B. Skinner describes a polyurethane containing composition for sealing sheet vinyl flooring.

U.S. Pat. No. 4,336,293 issued on Jun. 22, 1982, to Ronald R. Eiden describes an anti-slip mat comprising an undulating surface of a polyurethane.

U.S. Pat. No. 4,828,897 issued on May 9, 1989, to James M. Staneluis et al. describes reinforced polymeric composites comprising an outer polymeric skin and an inner polymeric foam core with embedded strands.

U.S. Pat. No. 5,733,629 issued on Mar. 31, 1998, to Thomas I. Insley describes a wet slip resistant sorbent floor covering having a texturized polymeric skin layer secured to a sorbent layer.

U.S. Pat. No. 5,854,144 issued on Dec. 29, 1998, to James K. Hawley describes a cushioned liner laminate made by laminating a printed plastic sheet to a foam material carried on a non-spun polyester fabric.

U.S. Pat. No. 6,130,174 issued on Oct. 10, 2000, to James K. Hawley describes a smooth surfaced foam laminate and the method of making same comprising lamination of a vinyl plastic film on a scrim layer coated with a foamed PVC plastic.

U.S. Pat. No. 6,159,583 issued on Dec. 12, 2000, to Mark A. Calkins describes a decorative non-adhering liner or mat comprising a printed vinyl sheet top, and a dotted PVC or PE surface layer on a polyethylene layer as the high friction material.

U.K. Patent Application No. 2 163 096 A published on Feb. 19, 1986, for Michael P. G. Mandt-Rauch describes a flexible laminated plastic sheet material comprising a polyester sheet, a polyester yarn netting, and a PVC layer, wherein the outer sheets are bonded by an adhesive.

None of the above inventions and patents, taken either singularly or in combination, is seen to describe the instant invention as claimed. Thus, a shelf liner/table top assembly solving the aforementioned problems is desired.

### SUMMARY OF THE INVENTION

The present invention is directed generally to shelf and tabletop covers or liners. More specifically, the invention is a four-layer, unitized, flexible plastic, decorated composition which can be utilized for covering shelves and tables. The plastic composition comprises a uniform sandwich or assembly of three layers of heat-bonded polymeric materials, including a layer of polyester mesh fabric between layers of polyvinyl chloride. Optionally, a decorative design can be imprinted on the top surface of the sandwich. The top layer is coated with a polyurethane layer to form a protective slippery top surface. The bottom polyvinyl chloride surface presents a non-slip surface for clinging on the surfaces of the shelf or tabletop.

Accordingly, it is a principal object of the invention to provide a flexible plastic cover composition having a non-slip and non-adhesive bottom surface.

It is another object of the invention to provide a plastic cover composition comprising a heat-bonded sandwich layer of a polyester mesh fabric between layers of polyvinyl chloride.

It is a further object of the invention to provide a plastic cover composition comprising a heat-bonded sandwich layer with a top coating of polyurethane.

Still another object of the invention is to provide a plastic cover comprising a heat-bonded sandwich layer having a decorative design covered by the top coating of polyurethane.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of the cover according to the present invention on a shelf or table, the layers of the cover being broken away and partly in section.

FIG. 2 is a schematic sectional view of the flexible plastic cover composition.

Similar reference characters denote corresponding features consistently throughout the attached drawings.

### DETAILED DESCRIPTION OF THE PREFERRED EMBODIMENTS

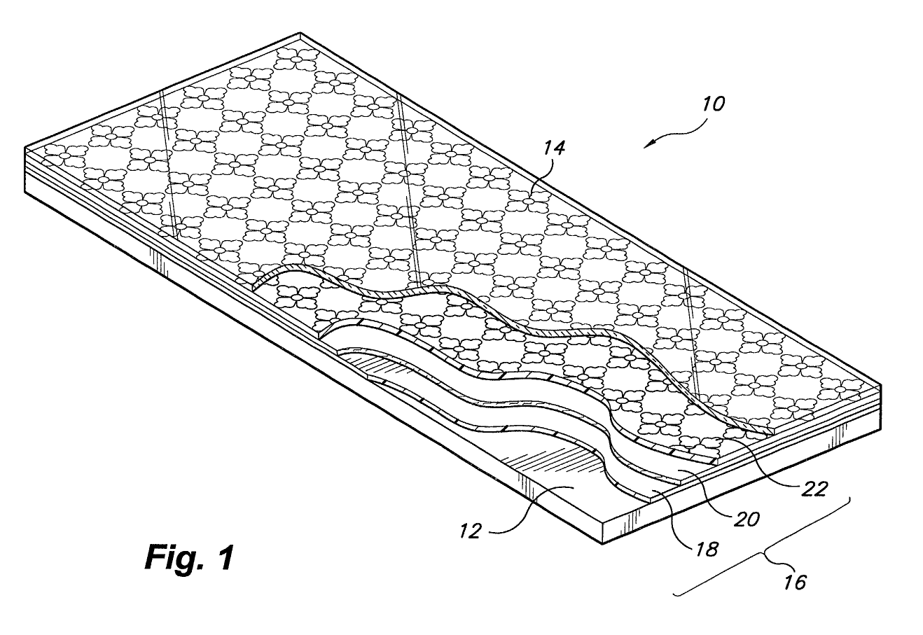

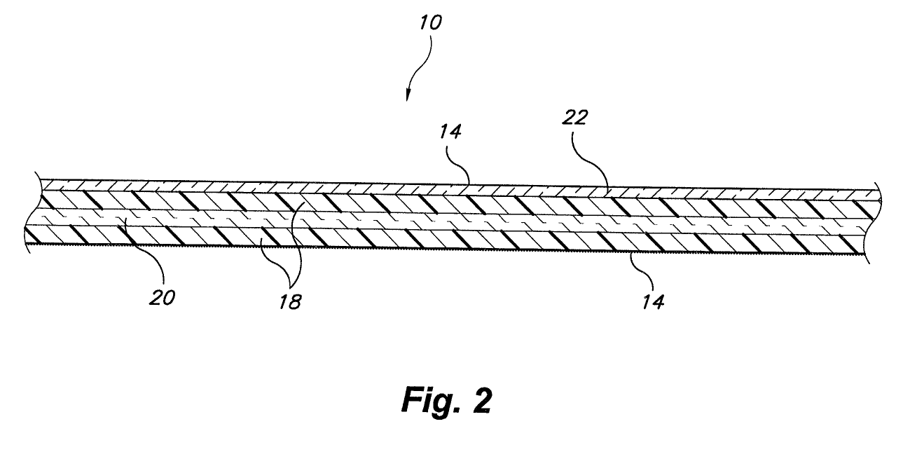

The present invention is directed to a flexible non-slip plastic cover 10 for use on a shelf as a liner or on a table top 12 as a cover as illustrated in FIGS. 1 and 2, and comprising a thin top surface layer 14 of polyurethane, and a sandwich layer 16 of polyvinyl chloride layers 18 over a fibrous polyester cord fabric center 20, whereby the top surface is substantially frictionless and the bottom surface is substantially non-slippable. Optionally, the upper layer of the sandwich layer is decorated with a pattern 22.

The invention is also directed to a process of making a flexible non-slip plastic shelf liner or table top cover 10 comprising the heat bonding of a plastic sandwich of a layer of a fibrous polyester cord fabric 20 between polyvinyl chloride (PVC) layers 18 at 350° F. to 425° F. over a tenter frame in rolls 3,000 to 4,000 ft. long and 12 inches wide, and coating the top surface with a thin layer of liquid polyurethane which is cured to form a frictionless surface which is protective. The plastic cover 10 has a non-slip bottom PVC 18 surface suitable for covering shelves or tables 12. optionally, decorative designs 22 are imprinted on the top layer 18 of the plastic sandwich 16 and covered with the previously mentioned polyurethane. The cover 10 is unaffected by weather and washing and can be left on outdoor picnic tables. The total thickness of the flexible non-slip plastic shelf liner or table top cover 10 is within the range of 1 to 10 mm.

Thus, a cover which can remain on a shelf or table-top by friction and still permit books, utensils, bottles and the like to readily slip on the top surface for retrieval has been shown. The material of the present invention can also be used as a siding material for temporarily covering a house under construction to protect wood, insulation, and other construction materials from the weather.

It is to be understood that the present invention is not limited to the embodiments described above, but encompasses any and all embodiments within the scope of the following claims.

I claim:

1. A flexible non-slip plastic shelf liner/table top cover comprising:
a flexible sandwich laminate sheet formed of polyvinyl chloride layers over a fibrous polyester cord fabric center, the sheet having a top surface and a bottom surface; and
a thin coating of polyurethane covering the top surface of said sheet;
whereby the top surface is substantially frictionless and the bottom surface is substantially non-slippable.

2. The flexible non-slip plastic shelf liner/table top cover according to claim 1, wherein the top surface of the sandwich layer is decorated.

3. The flexible non-slip plastic shelf liner/table top cover according to claim 1, wherein the total thickness of the flexible non-slip plastic shelf liner or table top cover is within the range of 1 to 10 mm.

4. A process of making a flexible non-slip plastic shelf liner/table top cover comprising the steps of:
heat bonding a plastic sandwich of a layer of a fibrous polyester cord fabric between layers of polyvinyl chloride in order to define a flat, flexible sheet having a top surface and a bottom surface;
coating the top surface with liquid polyurethane; and
curing the polyurethane;
whereby a flexible non-slip plastic shelf liner having a non-slip bottom surface suitable for covering shelves or tables is formed.

5. The process according to claim 4, further comprising the step of imprinting decorative designs on the top layer of the plastic sandwich, the polyurethane coating protecting the decorative designs from weather and washing.

6. The process according to claim 4, wherein the heat bonding and curing steps further comprise forming a sheet having a total thickness of the flexible non-slip plastic shelf liner or table top cover is within the range of 1 to 10 mm.

7. A flexible non-slip plastic house siding cover comprising:
a flexible sandwich laminate sheet formed of polyvinyl chloride layers over a fibrous polyester cord fabric center, the sheet having a top surface and a bottom surface; and
a thin coating of polyurethane covering the top surface of said sheet;
whereby the top surface is substantially frictionless and the bottom surface is substantially non-slippable.
